(19) United States
(12) Patent Application Publication
(10) Pub. No.: US 2025/0123106 A1
(43) Pub. Date: Apr. 17, 2025

(54) MEASUREMENT MODULE AND MEASUREMENT METHOD THEREOF

(71) Applicant: Qisda Corporation, Taoyuan City (TW)

(72) Inventor: Chien-Hsiang Kao, Taoyuan City (TW)

(73) Assignee: Qisda Corporation, Taoyuan City (TW)

(21) Appl. No.: 18/890,701

(22) Filed: Sep. 19, 2024

(30) Foreign Application Priority Data
Oct. 12, 2023 (CN) 202311317706.6

(51) Int. Cl. G01C 21/16; G01C 25/00

(52) U.S. Cl. CPC G01C 21/16; G01C 25/005

(57) ABSTRACT

A measurement module is adapted to be disposed in a target object, including a corner prism space and multiple measurement units. The corner prism space includes two bottom surfaces opposite to each other and multiple side surfaces. The measurement units are disposed on the side surfaces of the corner prism space respectively. Each of the measurement units has a positioning reference axis perpendicular to the corresponding side surface. A number of the measurement units is the same as a number of the side surfaces, and the number of the measurement units is at least five.

### CROSS-REFERENCE TO RELATED APPLICATION

This application claims the priority benefit of China application serial no. 202311317706.6, filed on Oct. 12, 2023. The entirety of the above-mentioned patent application is hereby incorporated by reference herein and made a part of this specification.

### BACKGROUND

### Technical Field

This disclosure relates to a measurement component, and in particular to a measurement module and a measurement method thereof.

### Description of Related Art

Inertial measurement unit (IMU) is currently widely used in devices such as cars, airplanes, drones, and tripod heads. The values of inertial measurement units are usually read and converted to Quaternions or Euler angles. Euler angles are more intuitive to understand, but can cause problems with singularities or gimbal locks, which can cause measurement distortions in some cases. The above problem can be solved by using the quaternion reading method. However, the quaternion reading method is more complex and difficult to calculate, and is difficult and time consuming to design.

### SUMMARY

The disclosure provides a measurement module and a measurement method thereof, capable of solving a problem of singularity in reading Euler angles and improving an angular range of measurement.

The disclosure provides a measurement module, adapted to be disposed in a target object, including a corner prism space and multiple measurement units. The corner prism space includes two bottom surfaces opposite to each other and multiple side surfaces. The measurement units are disposed on the side surfaces of the corner prism space respectively. Each of the measurement units has a positioning reference axis perpendicular to the corresponding side surfaces. A number of the measurement units is the same as a number of the side surfaces, and the number of the measurement units is at least five.

In an embodiment of the disclosure, an angle between two of the positioning reference axes adjacent to each other is less than 90 degrees.

In an embodiment of the disclosure, shapes of the two bottom surfaces are regular polygons, and angles between two of the positioning reference axes adjacent to each other are the same.

In an embodiment of the disclosure, the measurement units are disposed on a reference plane parallel to the two bottom surfaces.

In an embodiment of the disclosure, the measurement units are inertial measurement units.

In an embodiment of the disclosure, the measurement module further includes a carrying platform disposed in the corner prism space, the carrying platform includes multiple carrying surfaces, the carrying surfaces overlap the side surfaces, and a number of the carrying surfaces is the same as the number of the measurement units.

The disclosure further provides a measurement method including the following: a measurement module provided, the measurement module including a corner prism space and multiple measurement units, a method of respectively disposing the measurement units on multiple side surfaces of the corner prism space; a method of obtaining initial angle information respectively according to a motion state of a target object measured by each of the measurement units; a method of determining one of the measurement units as a main measurement unit according to the initial angle information; a method of modifying the corresponding initial angle information to post-compensation angle information according to a position of the main measurement unit; a method of reading the main measurement unit and the measurement units on the left and right sides of the main measurement unit after the target object moves to obtain post-motion angle information respectively; a method of determining whether to continue or replace the main measurement unit according to the post-motion angle information; and a method of modifying the corresponding post-motion angle information to the post-compensation angle information according to the position of the main measurement unit.

In an embodiment of the disclosure, the method of determining one of the measurement units as the main measurement unit according to the initial angle information further includes: selecting one measurement unit having the smallest initial angle information as the main measurement unit.

In an embodiment of the disclosure, the method of modifying the corresponding initial angle information to the post-compensation angle information according to the position of the main measurement unit further includes: adding compensation angle information to the initial angle information according to the position of the main measurement unit.

In an embodiment of the disclosure, the method of determining whether to continue or replace the main measurement unit according to the post-motion angle information further includes: selecting one measurement unit having the smallest post-motion angle information as a new main measurement unit.

Based on the above, in the measurement module and the measurement method thereof in the disclosure, the measurement module includes a corner prism space and multiple measurement units, and the measurement units are respectively disposed on multiple side surfaces of the corner prism space. A number of the measurement units is at least five. In this way, during the measurement, information about the motion state of the target object may be obtained by calculating the readings of different measurement units, thus avoiding the problem of singularity caused by the target object rotating 90 degrees and improving the angle range of the measurement.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of a measurement module disposed in a target object according to an embodiment of the disclosure.

FIG. 2 is a schematic diagram of a measurement module according to an embodiment of the disclosure.

FIG. 3 is a flow chart of steps of a measurement method according to an embodiment of the disclosure.

FIG. 4A to FIG. 4G are schematic diagrams of a measurement module performing a measurement method according to an embodiment of the disclosure.

### DESCRIPTION OF THE EMBODIMENTS

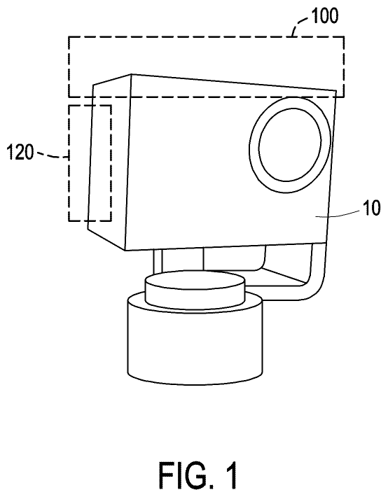

FIG. 1 is a schematic diagram of a measurement module disposed in a target object according to an embodiment of the disclosure. Referring to FIG. 1, the disclosure provides a measurement module 100 adapted to be disposed in a target object 10 to measure the angular velocity and acceleration of the target object 10 in three-dimensional space, and to solve a motion state of the target object 10. For example, the target object 10 is an airplane, a car, a drone, a mobile phone, or a photography tripod head, and the disclosure is not limited thereto. As shown in FIG. 1, the measurement module 100 of this embodiment may be designed to be disposed on one of planar surfaces of the target object 10 for measurement.

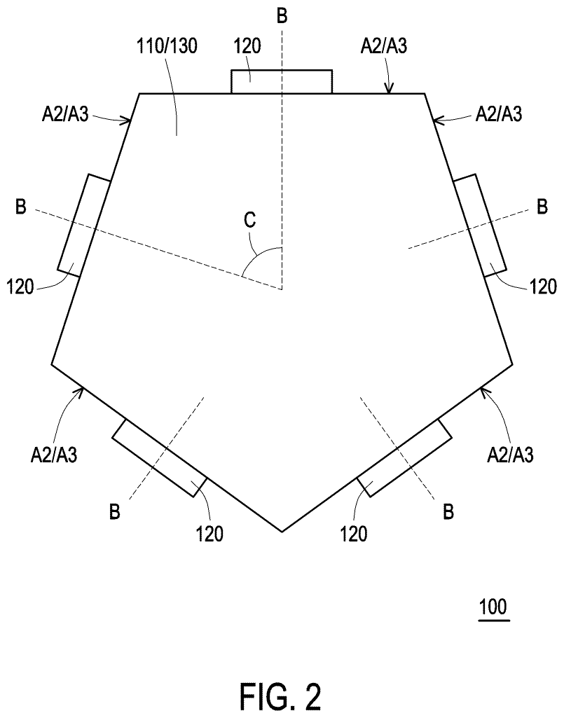

FIG. 2 is a schematic diagram of a measurement module according to an embodiment of the disclosure. Referring to FIG. 2, the measurement module 100 includes a corner prism space 110 and multiple measurement units 120. The corner prism space 110 includes two bottom surfaces A1 opposite to each other and multiple side surfaces A2, and the measurement units 120 are respectively disposed on the side surfaces A2 of the corner prism space 110. In different embodiments, the corner prism space 110 may be, for example, a solid corner prism object, a hollow corner prism outer frame, or a virtual space, and the disclosure is not limited thereto. For example, in this embodiment, the measurement module 100 further includes a carrying platform 130 disposed in the corner prism space 110. The carrying platform 130 includes multiple carrying surfaces A3, which overlap with the side surfaces A2 of the corner prism space 110. Therefore, a number of the carrying surfaces A3 is the same as a number of the measurement units 120.

The measurement units 120 are, for example, inertial measurement units (IMUs), respectively disposed on each of the side surfaces A2 of the corner prism space 110. That is, the number of the measurement units 120 is the same as a number of the side surfaces A2 of the corner prism space 110. Specifically, each of the measurement units 120 has a positioning reference axis B perpendicular to the corresponding side surfaces A2, and the positioning reference axes B are perpendicular to the side surfaces A2. In other words, during the measurement, the initial readings of the measurement units 120 are different. In a preferred embodiment, the measurement units 120 are disposed on a reference plane (not shown) parallel to the two bottom surfaces A1, that is, they are located at the same height for measurement. The number of the measurement units 120 is at least five, so that an angle C between two of the positioning reference axes B adjacent to each other is less than 90 degrees. In other words, shapes of the two bottom surfaces Al of the corner prism space 110 are polygons, and a number of side lengths is at least greater than five.

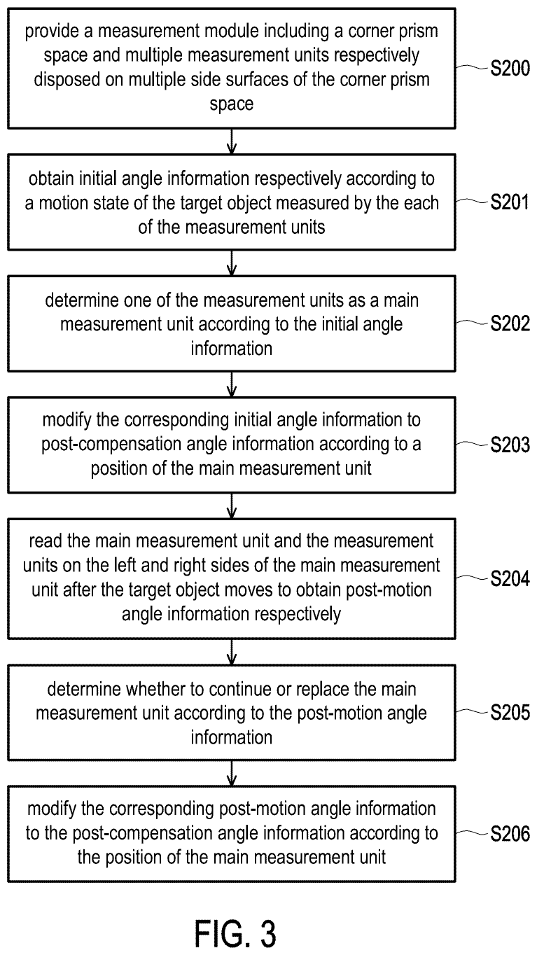

In an embodiment where the two bottom surfaces A1 are regular polygons, the shapes of the two bottom surfaces A1 of the corner prism space 110 are regular polygons, and the angles C between two of the positioning reference axes B adjacent to each other are the same. For example, in this embodiment, the corner prism space 110 is a regular pentagonal prism, so the shapes of the two bottom surfaces A1 of the corner prism space 110 are regular pentagons, and the number of the measurement units 120 is five, which are disposed on the each of the side surfaces A2 of the regular pentagonal prism, and the angles C between two of the positioning reference axes B adjacent to each other are the same. However, in different embodiments, the shapes of the two bottom surfaces A1 of the corner prism space 110 may be designed not to be regular polygons, and the disclosure is not limited thereto. In this way, during the measurement, information about the motion state of the target object 10 may be obtained by calculating the readings of different measurement units 120, thus avoiding the problem of singularity caused by the target object 10 rotating 90 degrees in the pitch angle, and improving the angle range of measurement. FIG. 3 is a flow chart of steps of a measurement method according to an embodiment of

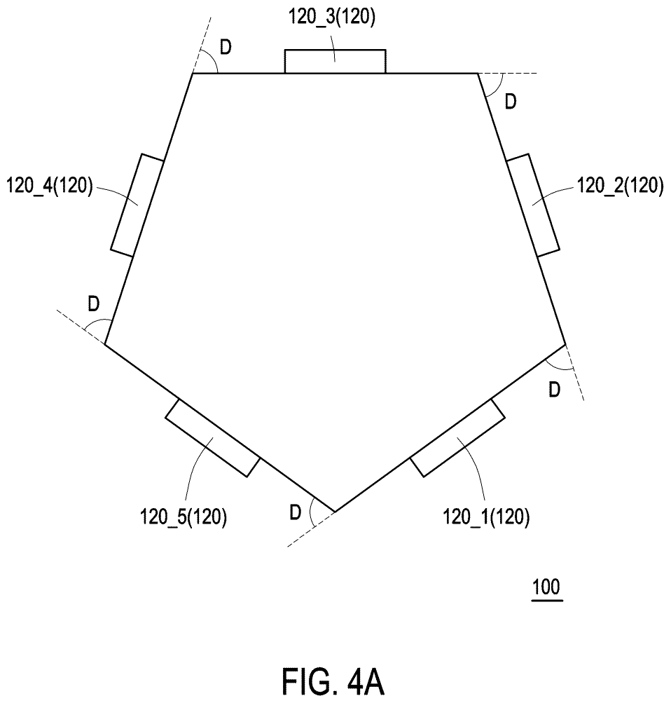

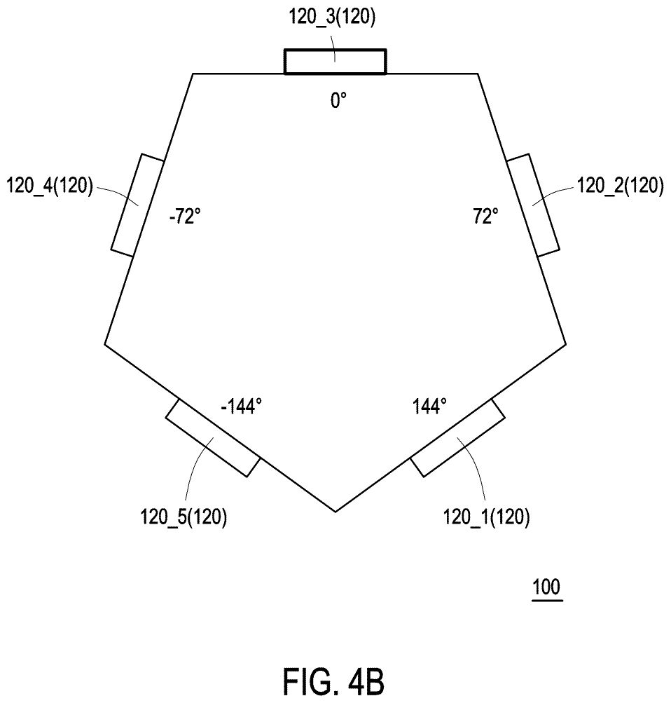

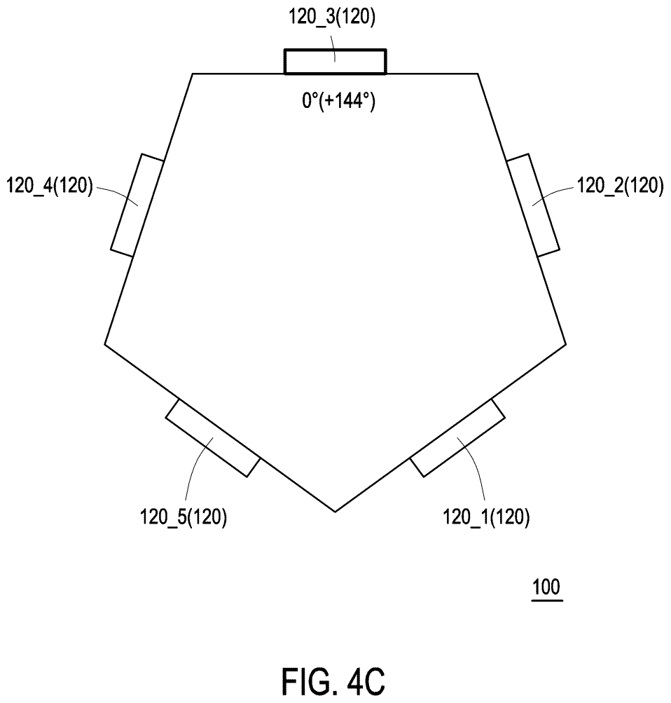

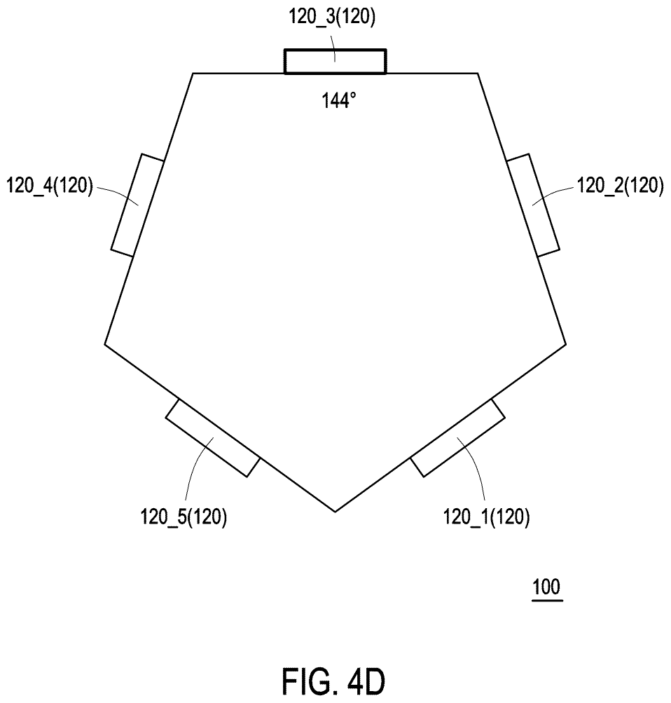

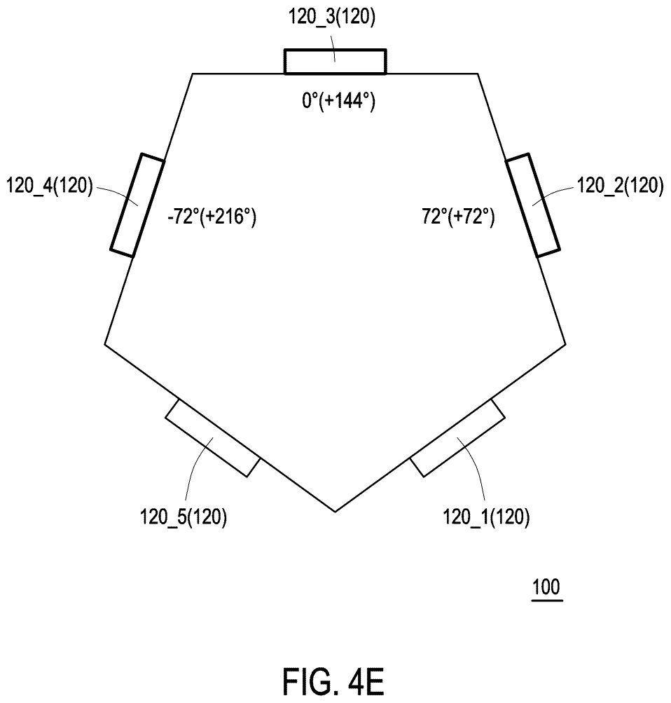

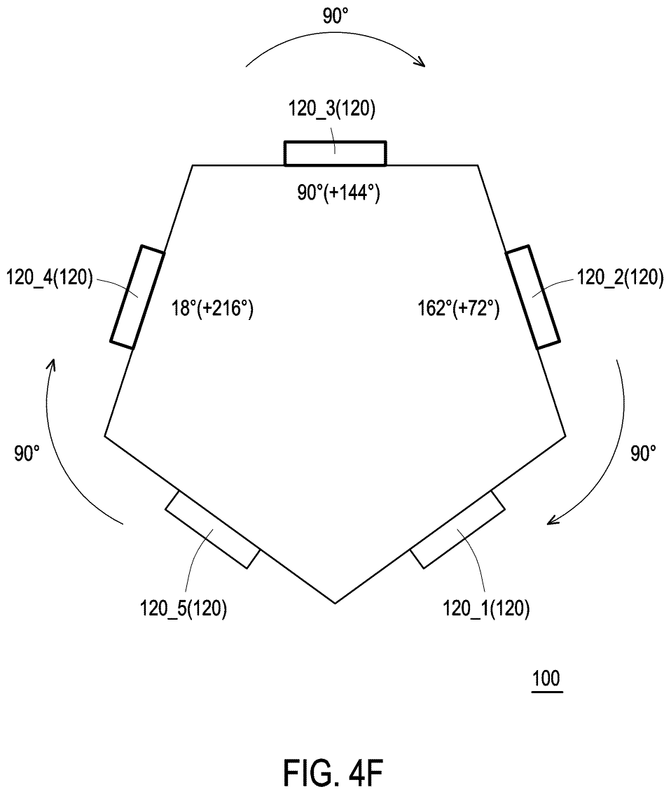

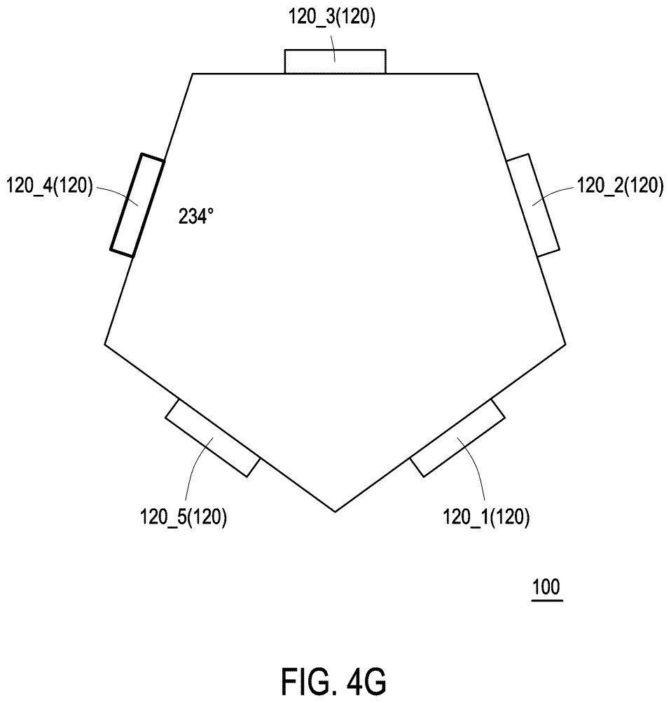

the disclosure. FIG. 4A to FIG. 4G are schematic diagrams of a measurement module performing a measurement method according to an embodiment of the disclosure. Referring to FIG. 3 to FIG. 4G, this embodiment provides a measurement method that can at least be applied to the measurement module 100 shown in FIG. 2, and is therefore illustrated hereinafter as an example. First, step S200 is performed to provide the measurement module 100 as shown in FIG. 2, which includes a corner prism space 110 and multiple measurement units 120 respectively disposed on multiple side surfaces A2 of the corner prism space 110.

Next, step S201 is performed to obtain initial angle information respectively according to a motion state of the target object 10 (as shown in FIG. 1) measured by the each of the measurement units 120. For example, in this embodiment, the measurement units 120 may be defined as a first measurement unit 120_1, a second measurement unit 120_2, a third measurement unit 120_3, a fourth measurement unit 120_4, and a fifth measurement unit 120_5 according to different positions, as shown in FIG. 4A. Since the corner prism space 110 in this embodiment is a regular pentagon, angles D of the adjacent measurement units 120 are all 72 degrees. Therefore, when the measurement units 120 make measurements, initial measurement readings of the first measurement unit 120_1 to the fifth measurement unit 120_5 are all different, and the difference in the angles read by the adjacent measurement units 120 is 72 degrees.

Next, step S202 is performed to determine one of the measurement units as a main measurement unit 120 according to the initial angle information. Specifically, in this step, one measurement unit having the smallest initial angle information is selected as the main measurement unit 120. For example, in this embodiment, when the initial measurement readings of the first measurement unit 120_1 to the fifth measurement unit 120_5 are, for example, 144 degrees, 72 degrees, 0 degrees, −72 degrees, or −144 degrees, then the third measurement unit 120_3 having the smallest initial measurement reading is selected as the main measurement unit 120, as shown in FIG. 4B.

Next, step S203 is performed to modify the corresponding initial angle information to post-compensation angle information according to a position of the main measurement unit 120. Specifically, in this step, compensation angle information is added to the initial angle information according to the position of the main measurement unit 120. For example, in this embodiment, the compensation angle information of the position of the third measurement unit 120_3 is 144 degrees, as shown in FIG. 4C. Therefore, after the compensation angle information is added to the initial angle information, a corrected reading of the third measurement unit 120_3 can be read as 144 degrees, as shown in FIG. 4D.

Next, step S204 is performed to read the main measurement unit 120 and the measurement units 120 on the left and right sides of the main measurement unit 120 after the target object moves to obtain post-motion angle information respectively, as shown in FIG. 4E. For example, in this embodiment, the measurement units 120 on the left and right sides of the third measurement unit 120_3 are the second measurement unit 120_2 and the fourth measurement unit 120_4 respectively, so the readings of the second measurement unit 120_2 to the fourth measurement unit 120_4 are read, as shown in FIG. 4E. When the target object 10 rotates 90 degrees, for example, the measurements of the second measurement unit 120_2 to the fourth measurement unit 120_4 will obtain post-motion readings of 162 degrees, 90 degrees, and 18 degrees, respectively, as shown in FIG. 4F.

Next, step S205 is performed to determine whether to continue or replace the main measurement unit 120 according to the post-motion angle information. Specifically, in this step, one measurement unit 120 having the smallest post-motion angle information is selected as a new main measurement unit 120. For example, in this embodiment, since the post-motion readings of the second measurement unit 120_2 to the fourth measurement unit 120_4 are 162 degrees, 90 degrees, and 18 degrees, the fourth measurement unit 120_4 having the smallest initial measurement reading is selected as the new main measurement unit 120, as shown in FIG. 4G.

Next, step S206 is performed to modify the corresponding post-motion angle information to the post-compensation angle information according to the position of the main measurement unit 120. For example, in this embodiment, similar to step S203, the compensation angle information of the position of the fourth measurement unit 120_4 is 216 degrees. Therefore, after the compensation angle information is added to the post-motion angle information, a corrected reading of the fourth measurement unit 120_4 can be read as 234 degrees. In other words, whenever the target object 10 moves, the measurement module 100 can read the value and determine whether to replace the main measurement unit 120, and then compensate the angle according to the different positions of the measurement units 120. In this way, during the measurement, information about the motion state of the target object 10 may be obtained by calculating the readings of different measurement units 120, thus avoiding the problem of singularity caused by the target object 10 rotating 90 degrees in the pitch angle, and improving the angle range of measurement.

To sum up, in the measurement module and the measurement method thereof in the disclosure, the measurement module includes a corner prism space and multiple measurement units, and the measurement units are respectively disposed on multiple side surfaces of the corner prism space. A number of the measurement units is at least five. In this way, during the measurement, information about the motion state of the target object may be obtained by calculating the readings of different measurement units, thus avoiding the problem of singularity caused by the target object rotating 90 degrees and improving the angle range of the measurement.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A measurement module, adapted to be disposed in a target object, comprising:
a corner prism space, comprising two bottom surfaces opposite to each other and a plurality of side surfaces; and
a plurality of measurement units, respectively disposed on the side surfaces of the corner prism space, and each of the measurement units having a positioning reference axis perpendicular to the corresponding side surfaces, wherein a number of the measurement units is the same as a number of the side surfaces, and the number of the measurement units is at least five.

2. The measurement module according to claim 1, wherein an angle between two of the positioning reference axes adjacent to each other is less than 90 degrees.

3. The measurement module according to claim 1, wherein shapes of the two bottom surfaces are regular polygons, and angles between two of the positioning reference axes adjacent to each other are the same.

4. The measurement module according to claim 1, wherein the measurement units are disposed on a reference plane parallel to the two bottom surfaces.

5. The measurement module according to claim 1, wherein the measurement units are inertial measurement units.

6. The measurement module according to claim 1, further comprising:
a carrying platform, disposed in the corner prism space, the carrying platform comprising a plurality of carrying surfaces, the carrying surfaces overlapping the side surfaces, and a number of the carrying surfaces being the same as the number of the measurement units.

7. A measurement method, comprising:
providing a measurement module, wherein the measurement module comprises a corner prism space and a plurality of measurement units, the measurement units are respectively disposed on a plurality of side surfaces of the corner prism space;
obtaining initial angle information respectively according to a motion state of a target object measured by each of the measurement units;
determining one of the measurement units as a main measurement unit according to the initial angle information;
modifying the corresponding initial angle information to post-compensation angle information according to a position of the main measurement unit;
after the target object moves, reading the main measurement unit and the measurement units on the left and right sides of the main measurement unit to obtain post-motion angle information respectively;
determining whether to continue or replace the main measurement unit according to the post-motion angle information; and
modifying the corresponding post-motion angle information to the post-compensation angle information according to the position of the main measurement unit.

8. The measurement method according to claim 7, wherein determining one of the measurement units as the main measurement unit according to the initial angle information further comprises:
selecting one measurement unit having the smallest initial angle information as the main measurement unit.

9. The measurement method according to claim 7, wherein modifying the corresponding initial angle information to the post-compensation angle information according to the position of the main measurement unit further comprises:
adding compensation angle information to the initial angle information according to the position of the main measurement unit.

10. The measurement method according to claim 7, wherein determining whether to continue or replace the main measurement unit according to the post-motion angle information further comprises:
selecting one measurement unit having the smallest post-motion angle information as a new main measurement unit.
